(19) United States
(12) Patent Application Publication
(10) Pub. No.: US 2003/0197929 A1
(43) Pub. Date: Oct. 23, 2003

(54) Binoculars for capturing images

(75) Inventor: Hsin-Feng Lee, Taichung (TW)

Correspondence Address: BACON & THOMAS, PLLC, 625 SLATERS LANE, FOURTH FLOOR, ALEXANDRIA, VA, 22314

(73) Assignee: ASIA OPTICAL CO., LTD., Taichung (TW)

(21) Appl. No.: 10/127,565

(22) Filed: Apr. 23, 2002

(51) Int. Cl. G02B 23/00

(52) U.S. Cl. 359/407; 359/399; 359/409; 359/431

(57) ABSTRACT

A binoculars for capturing images includes two optical systems and a image-capturing device installed in one optical system. The optical system having the image-capturing device includes a beam-splitting element, and the beam-splitting element divides a beam into two beams, wherein one beam is received by eye and another beam is received by the image-capturing device simultaneously. Consequently, the image-capturing device takes photos through the optical system of the binoculars.

### BACKGROUND OF THE INVENTION

1. Field of the Invention

The invention relates to a binocular, and more particularly to a binocular having a digital camera.

2. Description of the Related Art

A variety of instruments have been disclosed to view the scenery. These instruments include telescopes and binoculars. The telescope has an optical system consisting of an object lens, a prism and an eyeglass. The binoculars has two optical systems, wherein each system is the same with the telescope. The binoculars is more comfortable for viewing because it enables the user to view the field with both eyes. Therefore, the binoculars is extensively used for viewing different objects, such as birds, opera, etc. However, when an image requires being captured, the user must remove the binoculars from the eyes and then use a camera to capture the image.

Instruments having the functions of viewing and shooting objects are available now. For example, a camera with a telephoto lens can view a distant object besides capturing a photo. However, these cameras with telescopic function enable the user to view the field with one eye and make the user uncomfortable. The binoculars is fitter for human eyes than the camera with telescopic function. Besides, it is expensive to buy a camera and a binoculars simultaneously.

Ricoh Japan disclosed an apparatus including a telescope and a digital camera in the past. The user can take photos of the field viewed through the telescope by using the digital camera. However, the apparatus is still fit for one eye, and the view angle is still narrow.

### SUMMARY OF THE INVENTION

The object of the invention is to provide a binoculars for capturing images, wherein the binoculars has a digital camera and the digital camera captures the images via the optical system of the binoculars. Thus, binocular users can view the field and take photographs by using the binoculars at the same time.

According to the object of the invention, the binoculars for capturing images includes two optical system, and an image-capturing device. Each optical system includes an object lens set, an ocular lens set, and a prism set disposed between the object lens set and the ocular lens set. One optical system further includes a beam-splitting element, and the image of an object entering the optical system is separated into two images. The image-capturing device is installed in one optical system, and the image separated from the beam-splitting element can be captured by the image-capturing device.

The feature of the invention is that the image-capturing device captures images via the optical system of the binoculars.

The invention has an advantage of viewing and capturing the image of an object simultaneously.

### BRIEF DESCRIPTION OF THE DRAWINGS

Other aspects and advantages of the invention will become apparent from the following detailed description and the accompanying drawings.

FIG. 1 schematically shows a binoculars for capturing images according to the first embodiment of the invention;

FIG. 2 schematically shows the ray tracing in the binoculars for capturing images according to the first embodiment of the invention;

FIG. 3 schematically shows another binoculars for capturing images according to the second embodiment of the invention;

FIG. 4 schematically shows the ray tracing in the binoculars for capturing images according to the second embodiment of the invention.

### DETAILED DESCRIPTION OF THE EMBODIMENTS

First Embodiment

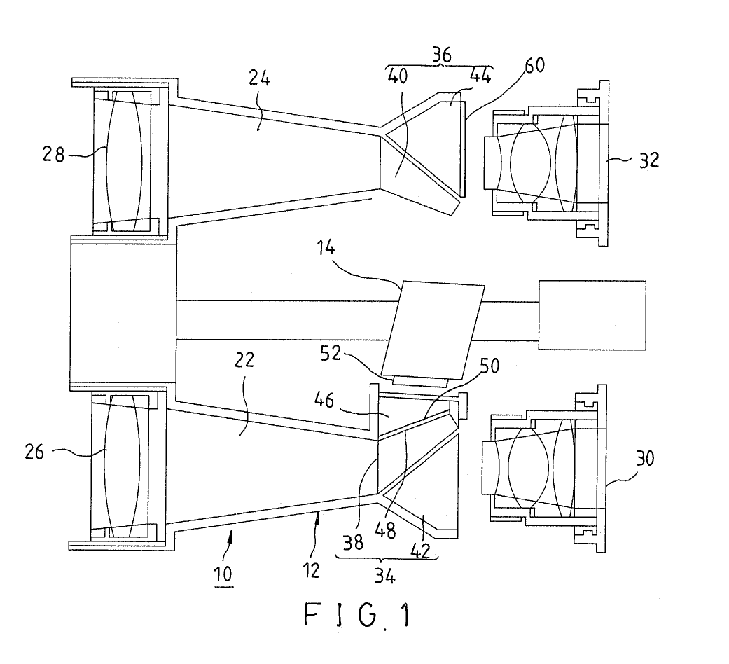

Referring to FIG. 1, a binoculars 10 for capturing images has a binocular mechanism 12, and an image-capturing device 14 is combined with the binocular mechanism 12. The binocular mechanism 12 includes a first optical system 22 and a second optical system 24. The optical systems 22 and 24 respectively have an object lens set 26, 28, an ocular lens set 30, 32, and a prism set 34, 36 disposed between the object lens set 26, 28 and the ocular lens set 30, 32. The prism sets 34 and 36 respectively have a front prism 38, 40 receiving light from the object lens set 26, 28, and a rear prism 42, 44 emitting light toward the ocular lens set 30, 32. The first optical system 22 further includes a beam-splitting device 50 adjacent to the prism set 34. In the first embodiment of the invention, the beam-splitting device 50 is a filter formed on the second-reflection surface 48 of the front prism 38. An image-capturing device 14 is combined with the first optical system 22, and the lens 52 of the image-capturing device 14 receives light passing the filter 50. A supplementary prism 46 is positioned on the filter 50, so as to reduce the optical path length between the object lens set 26 and the image-capturing device and protect thereof. Moreover, the optical path length of the first optical system 22 is equal to the optical path length measured from the object lens set 26 to the lens 52 of image-capturing device 14.

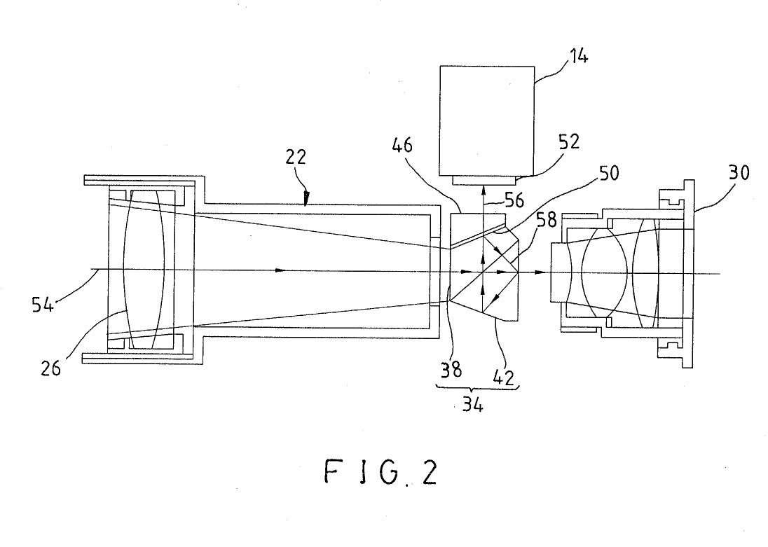

Referring to FIGS. 1 and 2, a beam 54 from an object (not shown) passes the object lens set 26, and enters the front prism 38 of the prism set 34. In the front prism 38, the beam 54 is reflected upon the filter 50 whereby the beam 54 is divided into two beams 56, 58. One beam 56 passes the supplementary prism 46, and enters the lens 52 of the image-capturing device 14. The image-capturing device 14 further captures the beam 56 from the object. Another beam 58 reflected by the filter 50 enters the rear prism 42 and is reflected three times. Next, the beam 58 emitted from the rear prism 42 travels through the ocular lens set 30 and is received by human eye. Thus, the image of the object is simultaneously captured and viewed via the optical systems 22, 24 of the binoculars 10.

Second Embodiment

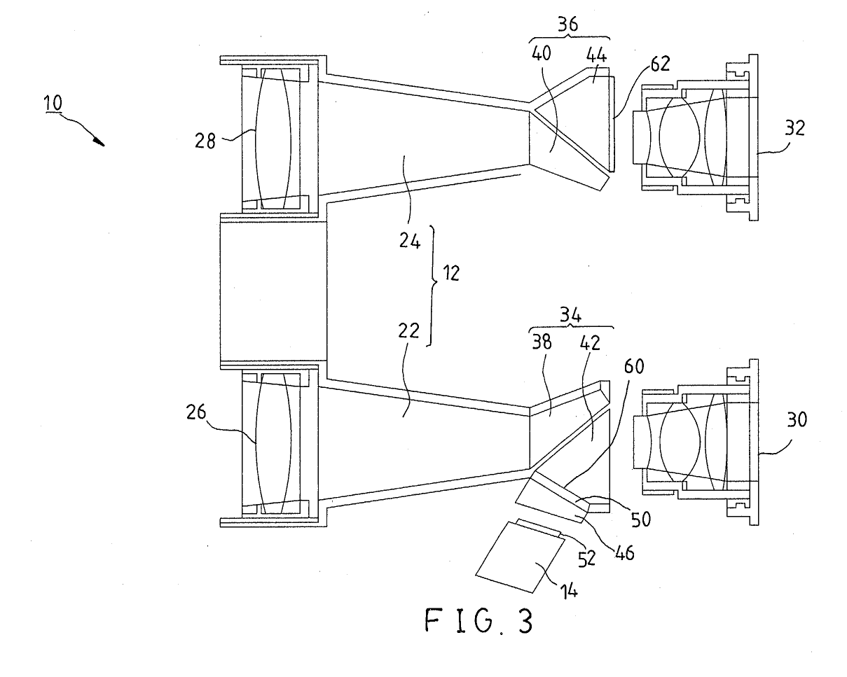

Referring to FIG. 3, a binoculars 10 for capturing images has a binocular mechanism 12, and an image-capturing device 14 is combined with the binocular mechanism 12. The binocular mechanism 12 includes a first optical system 22 and a second optical system 24. The optical systems 22 and 24 respectively have an object lens set 26, 28, an ocular lens set 30, 32, and a prism set 34, 36 disposed between the object lens set 26, 28 and the ocular lens set 30, 32. The prism sets 34 and 36 respectively have a front prism 38, 40 receiving light from the object lens set 26, 28, and a rear prism 42, 44 emitting light toward the ocular lens set 30, 32. The first optical system 22 further includes a beam-splitting device 46 adjacent to the prism set 34. In the second embodiment of the invention, the beam-splitting device 50 is a filter formed on the second-reflection surface 60 of the rear prism 42. A supplementary prism 46 is positioned on the filter 50, so as to protect thereof. An image-capturing device 14 is combined with the first optical system 22, and the lens 52 of the image-capturing device 14 receives light passing the filter 50. Moreover, the optical path length of the first optical system 22 is equal to the optical path length measured from the object lens set 26 to the lens 52 of image-capturing device 14.

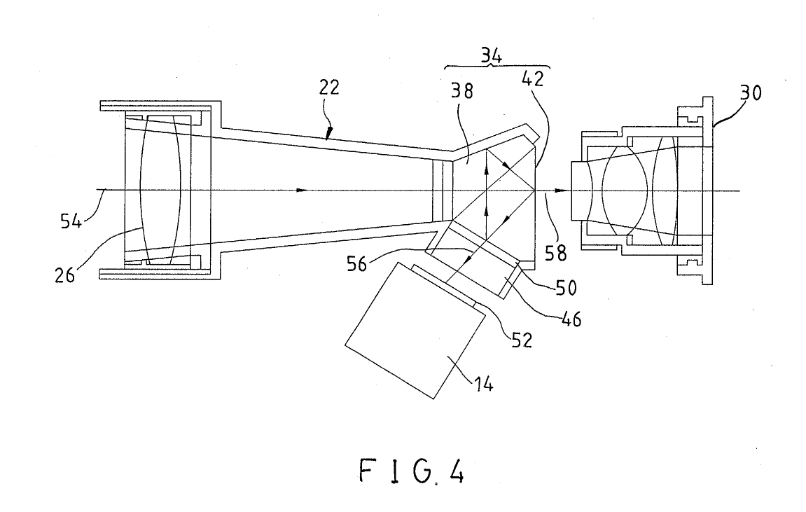

Referring to FIGS. 3 and 4, a beam 54 from an object (not shown) passes the object lens set 26 and enters the front prism 38 of the prism set 34. In the front prism 38, the beam 54 is reflected twice, and then enters the rear prism 42. In the rear prism 42, the beam 54 is reflected upon the filter 50 whereby the beam 54 is divided into two beams 56, 58. One beam 56 passes the supplementary prism 46, and enters the lens 52 of the image-capturing device 14. The image-capturing device 14 further captures the beam 56 from the object. Another beam 58 reflected by the filter 50 is reflected again by one surface of the rear prism 42 adjacent to the front prism 38. Next, the beam 58 emitted from the rear prism 42 travels through the ocular lens set 32 and is received by human eye. Thus, the image of the object is simultaneously captured and viewed via the optical systems 22, 24 of the binoculars 10.

In the first optical system 22, the beam 54 from an object is divided into two beams 56, 58. The intensity of the beam 56 received by the image-capturing device 14 is reduced, and so is the intensity of the beam 58, which is received by human eye. Therefore, the second optical system 24 further has a filter 62 for reducing light intensity. Moreover, when user receives light via the optical systems 22, 24, user's eyes won't feel different light intensity from the object.

In the invention, the image-capturing device 14 has a detector, such as CCD, CMOS for receiving light from the object.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A binoculars for capturing images, comprising:
a first optical system comprising an object lens set for receiving a beam from an object, a beam-splitting device for dividing the beam into two beams and an ocular lens set for projecting one beam on one eye;
a second optical system comprising an object lens set for receiving a beam from an object and an ocular lens set for projecting the beam on another eye; and
an image-capturing device having a lens and a detector and installed in the first optical system,
wherein the lens of the image-capturing device receives another beam divided from the beam-splitting device, and the detector captures the beam.

2. The binoculars for capturing images as claimed in claim 1, wherein the first optical system further comprises:
a prism set comprising a front prism and a rear prism, wherein the front prism guides the beam from the object lens set to the beam-splitting device, and the rear prism guides the beam divided from the beam-splitting device to the ocular lens set.

3. The binoculars for capturing images as claimed in claim 1, further comprising a supplementary prism disposed between the beam-splitting device and the image-capturing device and reducing the optical path length from the lens of the image-capturing device to the object lens set.

4. The binoculars for capturing images as claimed in claim 1, wherein the second optical system further comprises a filter for decreasing light intensity and balancing the light intensity received in eyes.

5. The binoculars for capturing images as claimed in claim 1, wherein the first optical system further comprises:
a prism set comprising a front prism and a rear prism, wherein the front prism guides the beam from the object lens set to the rear prism, and the rear prism guides the beam to the beam-splitting device and then guides the beam divided from the beam-splitting device to the ocular lens set.
